(19) United States
(12) Patent Application Publication
(10) Pub. No.: US 2011/0181145 A1
(43) Pub. Date: Jul. 28, 2011

(54) CONDUCTIVE BAR FOR ELECTRIC MACHINES

(76) Inventors: Thomas Baumann, Wettingen (CH); Francois Vannay, Rieden (CH)

(21) Appl. No.: 12/985,503

(22) Filed: Jan. 6, 2011

(30) Foreign Application Priority Data
Jan. 22, 2010 (EP) 10151381.0

(51) Int. Cl. H02K 23/26

(52) U.S. Cl. 310/201

(57) ABSTRACT

An conductive bar (1) for electric machines includes a plurality of interwoven conductive strands (2) insulated from one another and defining two side-by-side stacks (4). The outer surface of the conductive bar (1) is at least partly uneven.

This application claims priority under 35 U.S.C. §119 to European App. No. 10151381.0, filed 22 Jan. 2010, the entirety of which is incorporated by reference herein.

### BACKGROUND

1. Field of Endeavor

The present invention relates to a conductive bar for electric machines. In particular the present invention refers to rotating electric machines such as large generators with nominal voltage Vₙ>10 kV.

2. Brief Description of the Related Art

Conductive bar for electric machines, such as for example stator bars, are known to have conductive copper strands insulated from one another and interwoven to define a conductive bar.

Around this conductive bar a main insulation is then wrapped.

The main insulation is defined by a plurality of layers of a mica tape wrapped around the conductive bar; the mica tape is impregnated with an insulating resin that is cured to achieve a stiff, electrically insulating main insulation.

The mica tape is made of a mica paper bonded (for example by a bisphenol A/F adhesive) to a backing (for example a glass cloth).

Since the copper constituting the strands of the conductive bar and the mica constituting the mica tape have different physical properties, their behavior during thermal cycles is different; in this respect most important is the coefficient of thermal expansion CTE.

Due to the differences in coefficient of thermal expansion (CTE), stress generates at the interfaces between the copper strands and the insulation, which may finally lead to delamination of these layers and gap opening. In these gaps partial discharges may occur.

Partial discharges are known to be very detrimental for the lifetime of the main insulation and should be limited.

A further disadvantage of having gaps between copper strands and insulation is that heat transport out of the copper strands is hindered.

### SUMMARY

One of numerous aspects of the present invention includes a conductive bar by which the aforementioned problems of the known art are addressed.

Another aspect of the invention includes a conductive bar by which delamination of the main insulation may be avoided or largely reduced and, thus, also partial discharges are largely reduced.

A further aspect of the invention includes a conductive bar that, during operation, have an efficient heat transport out of the copper strands.

### BRIEF DESCRIPTION OF THE DRAWINGS

Further characteristics and advantages of the invention will be more apparent from the description of preferred but non-exclusive embodiments of the conductive bar for electric machines, illustrated by way of non-limiting examples in the accompanying drawings, in which:

FIGS. 1 and 2 respectively show a schematic cross section (FIG. 1) and a schematic enlarged longitudinal section (FIG. 2) of a conductive bar in a first embodiment of the invention;

FIGS. 3, 4 and 5 respectively show a schematic cross section (FIG. 3), an enlarged view of FIG. 3 (FIG. 4), and a schematic enlarged longitudinal section (FIG. 5) of a conductive bar in a second embodiment of the invention;

FIGS. 6 and 7 respectively show a schematic cross section (FIG. 6) of a conductive bar in a third embodiment of the invention and an enlarged view of FIG. 6 (FIG. 7); and

FIG. 8 shows a schematic longitudinal section of a conductive bar in a further embodiment of the invention.

### DETAILED DESCRIPTION OF EXEMPLARY EMBODIMENTS

With reference to the figures, a conductive bar generally identified by the reference number 1 is illustrated.

The conductive bar 1 includes a plurality of interwoven conductive strands 2 insulated from one another by an insulation 3 and defining (in the embodiments shown) two side-by-side stacks 4; in different embodiments the stacks may also be in a different number, for example four.

The outer surface of the conductive bar 1 is at least partly uneven.

In particular, the uneven surface is defined by protrusions 7 and/or recesses 8.

As shown in the figures, the conductive bar 1 has a substantially rectangular cross section and the protrusions 7 and/or recesses 8 are defined on its short sides 9.

Alternatively, the uneven surface may also be provided on the long sides 10 of the conductive bar 1 or also on both the short and long sides 9, 10.

The protrusions 7 and/or recesses 8 are defined by a covering applied onto the outer surface of the conductive bar 1.

Typically, the covering is defined by a putty 11.

Putty is well known in the art and is traditionally spread onto the short sides of the conductive bar to create an even and uniform layer as a basis for the mica tape to be wrapped thereon.

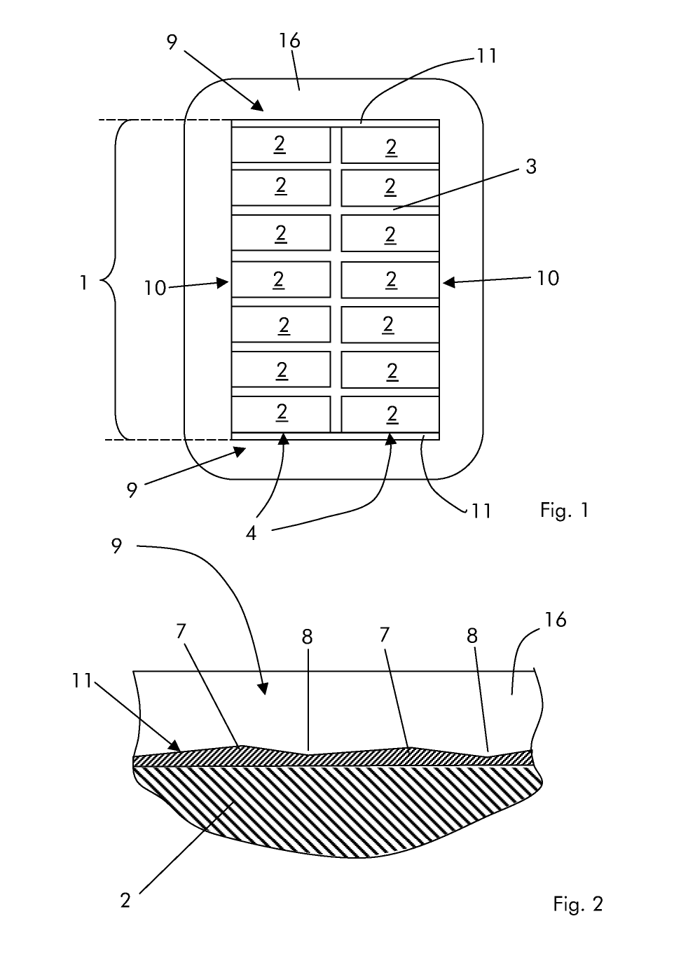

In a first embodiment of the invention (FIGS. 1 and 2) the putty 11 defines a wave-shaped profile.

This particular shape may be achieved by applying the putty 11 onto the conductive bar 1 (for example its short sides 9) and then pressing with a die having the required shape.

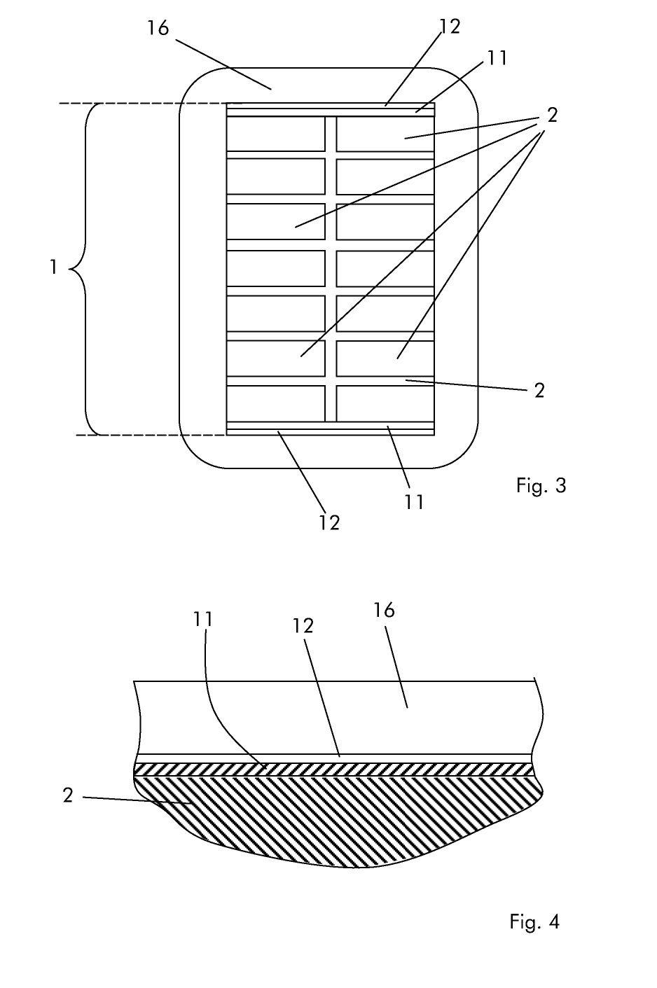

Alternatively (FIGS. 3, 4 and 5) the putty 11 may also define ribs 12 or it can carry ribs 12.

The ribs 12 are perpendicular to a longitudinal axis 14 of the conductive bar 1 and preferably have a triangular cross section.

The triangular cross section has an isosceles triangle and/or a sawtooth shape; in different examples the conductive bar 1 may have only ribs 12 with an isosceles triangle shape 12a or a sawtooth shape with different orientation 12b and 12c or a combination thereof.

In this case, the highest height of the ribs 12 (i.e., the distance from the base of each rib 12 to its top) is about twice the thickness of the mica tape to be wrapped around the conductive bar 1.

In particular, the highest height of the ribs 12 is less than 1 millimeter and preferably between 0.3-0.7 millimeters.

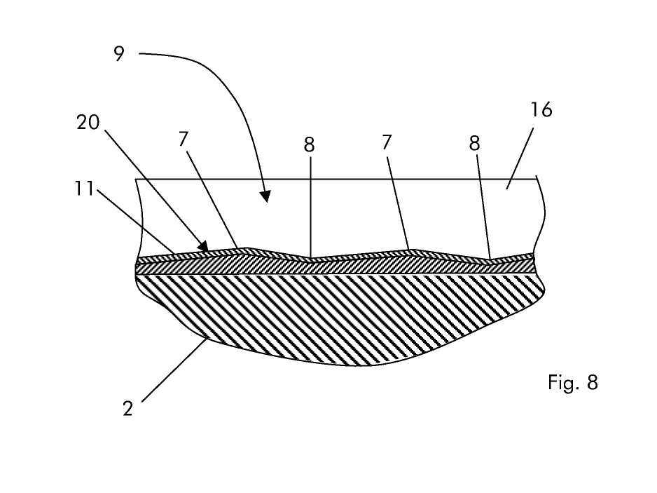

In addition, on top of the putty 11 one or more conductive strips 20 may be provided (FIG. 8), preferably having a laminated structure.

The conductive strips 20 have a shape reproducing the shape of the putty 11, i.e., the conductive strips 20 lie on the putty 11 and have a continuous contact with the putty 11, such that no voids (i.e., cavities filled with gas or air between the putty 11 and the conductive strips 20) are created.

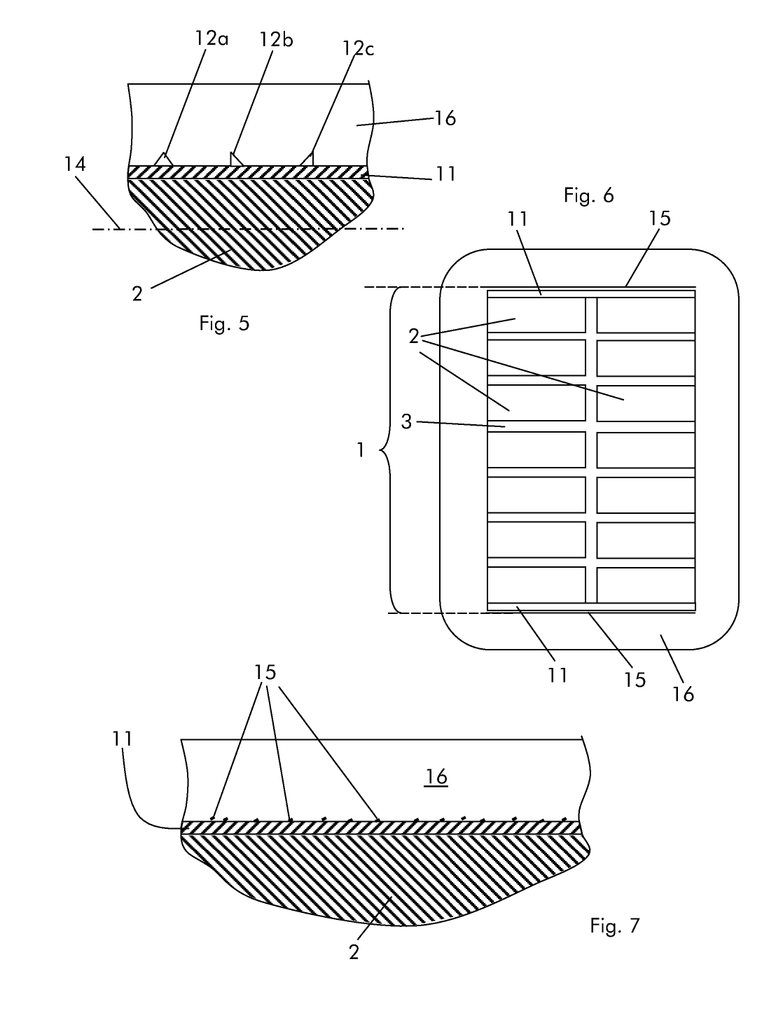

In a further embodiment of the invention (FIGS. 6 and 7), the putty 11 is at least partly covered with a layer of preferably nonconductive grains 15.

These grains 15 are for example sand, glass, corundum and their size is less than 0.5 millimeters and preferably about 0.25-0.45 millimeters.

Around the conductive bar 1 with the putty 11, a mica tape 16 is then wrapped, forming one or usually more than one layer; the mica tape 16 is then impregnated with a resin and is cured.

During curing, insulation made of mica tape 16 impregnated with the resin is formed and is chemically bonded (via the putty 11) to the conductive bar 1; in addition, the insulation is also mechanically bonded (via the particular profile of the putty and/or thanks to the components contained therein) to the conductive bar 1.

In fact the putty 11 that is applied on the conductive bar 1 withstands the same deformations as the conductive bar 1.

This lets the putty 11 stretch the mica tape 16 (because of the thermal cycles that occur during operation), such that it also withstands the same deformations as the conductive bar 1.

Therefore, since the conductive bar 1 and the mica tape 16 withstand the same (or almost the same) deformations, no delamination occurs.

Naturally the features described may be independently provided from one another.

In practice the materials used and the dimensions can be chosen at will according to requirements and to the state of the art.

### REFERENCE NUMBERS

1 conductive bar

2 conductive strands

3 insulation

4 stacks

7 projections

8 recesses

9 short sides of 1

10 long sides of 1

11 putty

12 ribs

12a isosceles triangle shape of 12

12b, 12c sawtooth shape of 12

14 axis of 1

15 grains

16 mica tape

20 conductive strip

While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

We claim:

1. A conductive bar for electric machines, the bar comprising:
a plurality of interwoven conductive strands insulated from one another and defining at least two side-by-side stacks;
wherein the outer surface of the conductive bar is at least partly uneven.

2. A conductive bar as claimed in claim 1, wherein said uneven surface comprises and is defined by projections, recesses, or both.

3. A conductive bar as claimed in claim 2, wherein:
said conductive bar has a substantially rectangular cross section having short sides; and
said protrusions, recesses, or both are defined on the short sides of the conductive bar.

4. A conductive bar as claimed in claim 2, further comprising:
a covering applied on the outer surface of the conductive bar, said projections, recesses, or both being defined by the covering.

5. A conductive bar as claimed in claim 4, wherein said covering consists essentially of a putty.

6. A conductive bar as claimed in claim 5, wherein said putty defines a wave-shaped profile.

7. A conductive bar as claimed in claim 5, wherein said putty defines or carries ribs.

8. A conductive bar as claimed in claim 7, wherein said ribs are perpendicular to a longitudinal axis of the conductive bar.

9. A Conductive bar as claimed in claim 8, wherein said ribs have a triangular cross section.

10. A conductive bar as claimed in claim 9, wherein said triangular cross section defines an isosceles triangle, a sawtooth shape, or both.

11. A conductive bar as claimed in claim 10, further comprising:
a mica tape wrapped around the at least partly uneven outer surface, the tape having a thickness; and
wherein a highest height of said ribs is about twice the thickness of the mica tape.

12. A conductive bar as claimed in claim 5, further comprising:
a conductive strip having a shape reproducing the shape of the putty, the conductive strip covering the putty.

13. A conductive bar as claimed in claim 12, wherein said conductive strip comprises a laminate structure.

14. A conductive bar as claimed in claim 5, further comprising:
a layer of grains at least partly covering the putty.

15. A conductive bar as claimed in claim 14, wherein said grains are nonconductive.

16. A conductive bar as claimed in claim 1, further comprising:
an insulation including a mica tape impregnated with a resin, the insulating being positioned around said putty.
